(19) United States
(12) Patent Application Publication
(10) Pub. No.: US 2008/0019659 A1
(43) Pub. Date: Jan. 24, 2008

(54) Photonic fabric display with controlled graphic pattern, color, luminescence intensity, and light self-amplification

(76) Inventors: Xiaoming Tao, Hong Kong (CN); Xiaoyin Cheng, Hong Kong (CN); Jianming Yu, Hong Kong (CN); Lijie Liu, Hong Kong (CN); Wang-wah Wong, Hong Kong (CN); Wing-kwong Tam, Hong Kong (CN)

Correspondence Address: EVAN LAW GROUP LLC, 600 WEST JACKSON BLVD., SUITE 625, CHICAGO, IL, 60661, US

(21) Appl. No.: 11/586,730

(22) Filed: Oct. 26, 2006

Related U.S. Application Data
(60) Provisional application No. 60/730,036, filed on Oct. 26, 2005.

(51) Int. Cl. G02B 6/00

(52) U.S. Cl. 385/147

(57) ABSTRACT

A photonic fabric display wherein graphic patterns, color, luminescence intensity, and light self-amplification are controllable. Incorporated in the fabric display are a number of photonic fibers which contain a converter either coated on a surface of the photonic fibers or inside said photonic fibers and a light source, such as LEDs, is connected to the end of the photonic fibers by using an efficient coupler.

### FIELD OF THE INVENTION

The present invention relates to photonic fabric displays and the method of fabricating such displays. More specifically, it relates photonic fabric displays with controlled graphic patterns, color, luminescence intensity, and light self-amplification by applying a coating of a converter on the surface of photonic fibers of the displays and connecting to a light source with a high efficient coupler.

### BACKGROUND OF THE INVENTION

It is known to weave optical fibers into a panel. For example, U.S. Pat. No. disclosed a panel incorporated with optical fibers. To make such panel useful as a display means, the surface of the optical fiber must be disrupted via a surface treatment method at desired locations so that that light will be emitted laterally from these locations, forming an intended graphic pattern or image. Various methods are known for such surface treatment, for example, chemical treatment, laser treatment, mechanical treatment, etc. However, there is a continuous need for better ways to increase lateral luminescence intensity and to control patterns to be displayed.

### SUMMARY OF THE INVENTION

Accordingly, as an object of the present invention, there is provided a photonic display with a coating of converter which can change the wavelength of the light emitted and amplify the intensity of the emitting light at a desired wavelength. As another of object of the present invention, there is provided a coupler between a light source such as LEDs and the end of the photonic fiber incorporated in the photonic display, which can achieve a near 100% coupling efficiency.

The photonic fabric display according to the present invention has controlled pattern, colour, luminescence intensity, and light self-amplification. The constituent photonic fibers can be polymer-based or silica-based, which are capable of controlling colour, luminescence intensity, and self-amplification. These optical performances are obtained by formation of nano-scaled structure, adding nano-particles and gain materials inside or on the surface of the fibers. The photonic fibers can be single mode optical fiber and/or multi mode optical fiber, with a diameter in the range of 0.01 to 3.0 mm, and more preferably, 0.025 to 1.0 mm . The fibers are made in silica or polymeric materials, such as PMMA (PolyMethylMethaAcrylate), PS (PolyStyrole), PC (PolyCarbonate), PEA (PolyEthylAcrylate), PEMA (PolyEthyMethaAcrylate), PMMAIPEMA (PolyMethyl/PolyMethylAcrylate), etc. These photonic fibers convey a light flow from one end to the other end, and get off the lateral light only in the locations in predetermined locations. By incorporating these photonic fibers into a piece of fabric, a luminescent fabric display is therefore fabricated. The applied photonic fibers can be single fibers and/or multi-filament, which can be untreated and/or wrapped, twisted, and braided by using nature fiber, continuous filament, staple yarn, and fiber with optical gain materials, etc. The wrapping or twisting fiber can be cotton, wool, silk, and flax, synthetic and manmade materials.

The structure of fabric display can be based on various textile architectures such as weaving, knitting, braiding, non-woven, or embroideries, as well as textile assemblies. The preferred structure is woven architectures by using loom, such as Jacquard, Dobby, and digital weaving machine controlled by computer or manipulated by hand. The photonic fibers can be served as weft yarn and/or warp yarn. The woven architectures can be two dimensions, and three dimensions.

The various color (and/or no color) patterns can be obtained by printing with offset printing, gravure printing, letterpress printing, screen printing, digital printing, etc. The fluorescent dyes, laser dyes, conductive polymers, and nano-particles added into print paste have been adapted to improve luminescence intensity, scattering intensity, light self-amplification, and contrast. The nano-particles can be Titania, Zinc Oxide, Zirconia, and nano metal particles (ranging from 10 nm to 100 nm) to increase surface plasma. The laser dyes can be Coumarinic compounds, Rhodaminic compounds, novel macromolecule laser dyes (such as PPV, PPH), and inorganic laser dyes, etc.

Before printing, surface chemical and ultrasonic treatments have been made in the location with patterns to improve the lateral illumination. After printing, fine surface treatments controlled by computer, such as mechanical treatment, laser treatment, and chemical treatment, have been performed to the photonic fabric display according to the patterns and shades of color. Forceps, nipper, pliers, tweezers, embossing roller, and cylinders can be adapted in the mechanical treatment.

Depending on the design and application, fabric display can be treated with antibacterial, water-, oil-, soil-proof finishing treatments, and self-cleaning treatment. These transparent protective layers allow light to emit out, but isolates the display from the environment.

After finishing weaving, color pattern printing, and surface treatments, the terminals of photonic fiber at the edge are bounded together, cured by UV curing glue and/or thermal curing processes, cut along the vertical section, and polished with polisher by using various finishing papers.

The polished photonic fiber terminals are then coupled with various light sources. The light sources can be LEDs with different wave lengths, lasers, and lamps, etc. The connector for coupling is made by plastic or metal materials according to the different design and application. The colour and luminescence intensity can be tuned by adapting various fluorescent dyes, laser dyes and various colour LEDs controlled by predetermined circuits. Constant current drive circuit for ultra-light LED and dynamic scanning display circuit for multiple LEDs can be adapted to have different luminescent effects. The PCBs (printed circuit boards) are designed as flexibility and miniaturization to easily integrate in the apparel, arts, furniture etc. The rechargeable batteries or AC-DC converters can be adapted as power supply for various light sources.

### BRIEF DESCRIPTION OF DRAWINGS

FIG. 1 is a flow-chart showing the main step of the fabrication process of photonic fabric of the present invention;

FIG. 2 is schematic drawings showing wrapping a single phonic fiber or bundled phonic fibers according to the present invention;

FIG. 3 is an example of a photonic panel with a controlled pattern according to the present invention;

FIG. 4 is schematic drawings showing the coupling structure between the end of photonic fibers' and LED according to the present invention;

FIG. 5 is an exemplary graphic image that can be displayed on the photonic fabric panel according to the present invention.

### DETAILED DESCRIPTION OF PARTICULAR EMBODIMENTS

Now the preferred embodiments according to the present invention will be described in details with reference to the accompanying drawings.

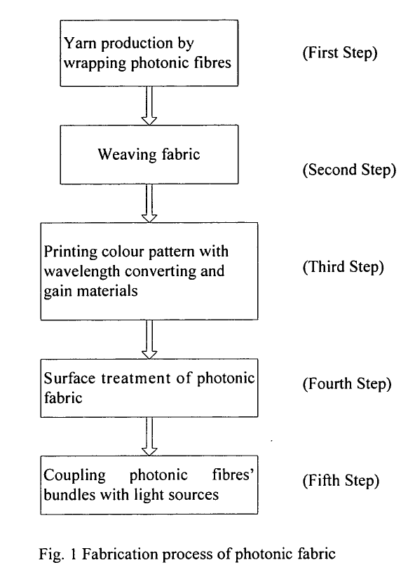

FIG. 1 is a typical fabrication process of photonic fabric with controlled pattern, color change, luminescence intensity, and light self-amplification according to the present invention. Photonic fibers used in the method have excellent transmittance and workability. The process may comprise: a first step of yarn production by wrapping photonic fiber; a second step of weaving fabric; a third step of printing color pattern with wavelength converting and gain materials, a fourth step of surface treatment of photonic fabric, a fifth step of coupling photonic fibers' bundles with light source. In addition, the method may further comprise a step of adding a water repellent or soil release film on the surface of the photonic fabric surface.

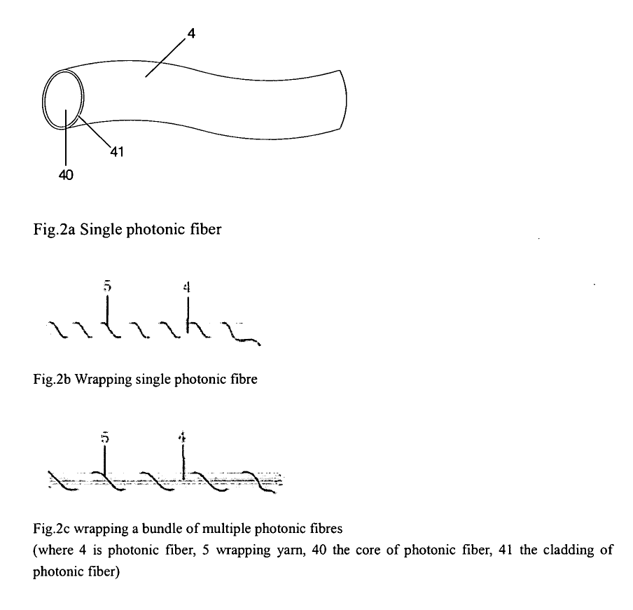

As shown in FIG. 2, in first step, a bare or unjacketed photonic fiber 4 having a core 40 and a cladding 41 is wrapped by using the nature or manmade fibers 5. The applied photonic fibers can be single fibers and/or multi-filament, such as single photonic fiber shown in FIG. 2b, a bundle of multiple photonic fibers shown in FIG. 2c. It should be noticed that the applied photonic fibers can also be untreated as shown in FIG. 2a.

The photonic fibers can be single mode photonic fiber and /or multimode photonic fiber, which diameter is in a range of 0.01 to 3.0 mm, and more preferably, 0.025 mm to 1.0 mm. The fibers are made in silica or polymeric materials, such as PMMA (PolyMethylMethaAcrylate), PS (PolyStyrole), PC (PolyCarbonate), PEA (PolyEthylAcrylate), PEMA (PolyEthyMethaAcrylate), PMMA/PEMA (PolyMethyl/PolyMethylAcrylate), etc. These photonic fibers are convey a light flow from one of its end to the other end and get off the lateral light only in the locations we need.

The applied photonic fiber has excellent transmittance and workability. The wrapping fiber can be nature fiber, continuous filament, staple yarn, and fiber with optical gain materials, etc. The materials can be cotton, wool, silk, and flax, metal, and synthetic and manmade materials.

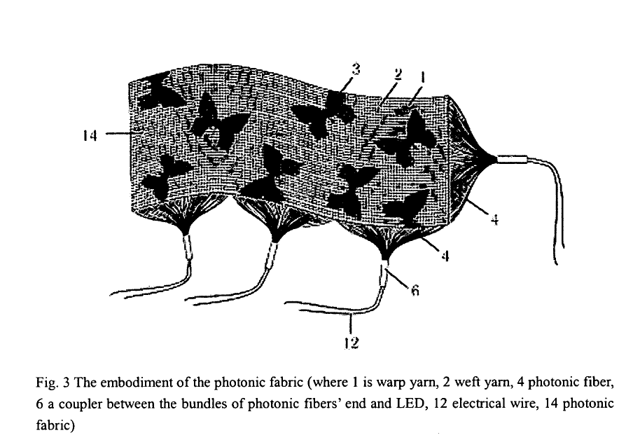

In the second step, the wrapping photonic fibers are woven by using loom, such as Jacquard, Dobby, and digital weaving machine controlled by computer or manipulated by hand. The embodiment of the photonic fabric 14 is shown in FIG. 3. The weft yarn 1 and warp yarn 2 can be yarn production by wrapping photonic fibers. The pattern (butterfly) 3 can be woven in jacquard machine and (or) printed by screen printing. At the edges of the photonic fabric, the wrapped fibers are wiped off and the photonic fibers are bounded together, and connected with LEDs with coupler 6. The electric wire 12 is connected with the electrical power.

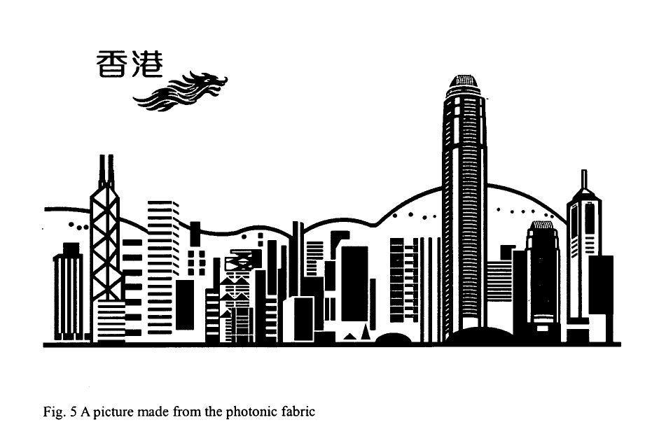

In the third step, the various color (and /or no color) patterns are printed by screen printing. The other printing procedure can also be used, such as letterpress printing, screen printing, digital printing, etc. The butterfly pattern is shown in FIG. 3. The Hong Kong harbour view pattern (shown in FIG. 5) is also obtained by screen printing.

During the third step, certain wavelength converting materials, such as dyes, polymers, semiconductors, and phosphors, and nano-particles are mixed with print paste, then coating in the surface of the photonic fabric. These materials can change the colour and improve luminescence intensity, scattering intensity, light self-amplification, and contrast.

Certain wavelength converting materials, such as dyes, polymers, semiconductors, and phosphors, can be excited by light at a certain wavelength and emit light at another wavelength. In the visible range, this conversion causes colour change. The fluorescent dyes/pigment can be lucifer yellow CH, Fura Red, POPO-3 iodide, BODIPY TMR-X, BO-PRO-3 iodide, Calcium Orange, SNARF-1 carboxylic acid. The laser dyes can be Coumarin, Stibene, Rhodaminic compounds (such as Coumarin 307, 480, and 540, Stipene 420, Rhodamine 590), conducting polymers (such as PPV, PPH), and inorganic laser crystal powder, etc.

In a dye solution with suspension of nano- or sub-micron sized dielectric particles, or a composite comprising a polymeric matrix, doped with optical gain materials, and randomly distributed nano- or sub-micron sized particles, an incident light will be scattered and the path length of the photons will be increased. This causes amplified spontaneous emission (ASE), where light amplification can be realized at the wavelength where the ASE occurs. The nano-particles can be Titania, Zinc Oxide, Zirconia, and nano metal particles (range from 10 nm to 100 nm).

It should be noticed that it have the similar effects to add the above mentioned materials inside the core of photonic fiber during the photonic fiber fabrication process. To improve the effect, these materials can also be mixed with chemical solvent during the chemical surface treatment of photonic fibers in the fourth step or print the materials again after the fourth step.

In fourth step, surface treatment, such as chemical treatment, laser treatment, and mechanical treatment have been made in the location with patterns to improve the lateral illumination. This treatment is controlled by computer and can be performed to the photonic fabric according to the various patterns and shade of color. The advantage of laser treatment is that side-emitting intensity and pattern are controllable. By control the laser energy and the exposure time, the leaking light from photonic fiber can be controlled. Chemical surface treatment can achieve well-proportioned side-emitting effects. However, it maybe damages the photonic fabric. So it is important to select suitable solvent and procedure. By screening different solvents, recipes, and procedures, we find that MEE+TiO2 nanoparticle treatment have more obvious side-emitting effect.

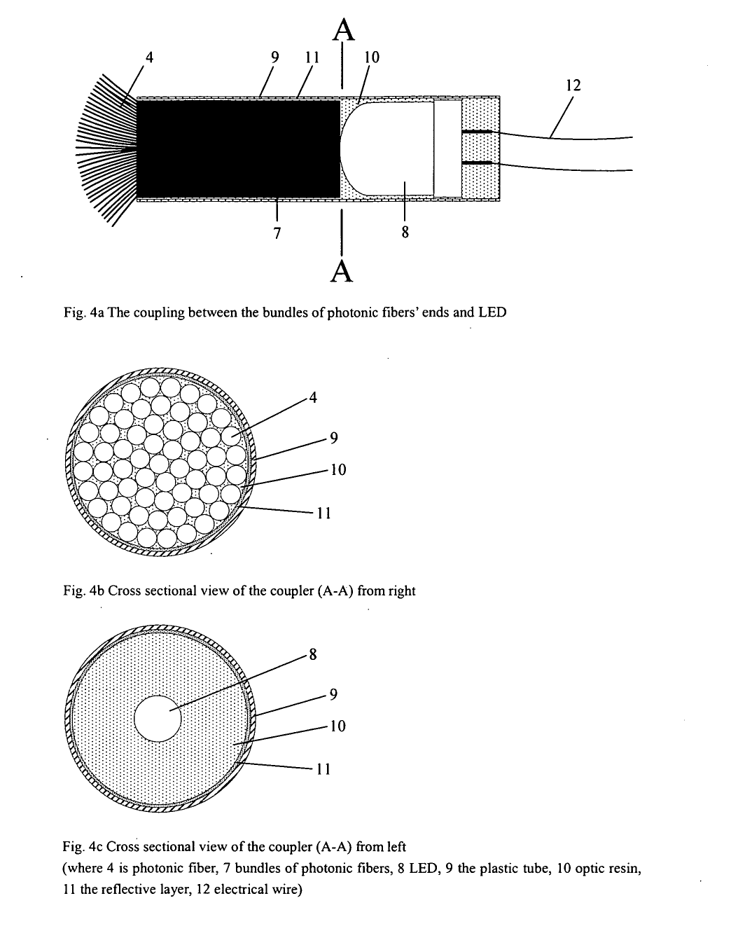

In fifth step, a coupler 6 between the bundles of photonic fibers' end and the light source (such as LEDs) is applied to improve the coupling efficiency. The typical structure of the coupler 6 is shown in FIG. 4. The fabrication process of a coupler is described as the following: Firstly, mix the part A and Part B of optic resin 10, stir them carefully and sitting them in the low temperature chamber to remove the air in the mixed resin; Secondly, bind the terminals of photonic fiber 4 at the edge, cut along the vertical section, remove the gas absorbed on the surface of photonic fibers by air suction, dip the bundle of photonic fibers into mixed optic resin, embed the plastic tube 9 coated with a reflective layer 11; Thirdly, put optic resin in the plastic tube; Finally, remove the gas on the surface of LED, dip LED into the mixed optic resin, put LED into the plastic tube, make sure that LED is close to the end of photonic fibers tightly, and cure them at 50° C. in a temperature chamber.

The refractive index of optic resin used is very close with that of PMMA core of photonic fiber and same with that of the LED cover. There is no air between the LED and the bundle of photonic fibers. So the light propagates into the fibers with minimal reflection losses at LED/air and air/fiber ends. The reflective film coated inside the plastic tube serves as cylindrical mirror which can limit the light beam inside the cylindrical mirror and decrease leakage loss. An important consideration in selecting suitable substance to fill the gap between the LED and the end of photonic fabrics is the reflective index, which should be as close as possible to the reflective index of the cover/cap of the LED and of core of the photonic fiber

The light sources can be LEDs with different wave lengths, lasers, and lamps, etc. The connector for coupling is made by plastic or metal materials according to the different design and application. The color and luminescence intensity can also be tuned by adapting various colour LEDs controlled by predetermined circuits. Constant current drive circuit for ultra-light LED and dynamic scanning display circuit for multiple LEDs can be adapted to have different luminescent effects. The PCBs (printed circuit boards) are designed as flexibility and miniaturization to easily integrate in the apparel, arts, furniture etc. The rechargeable batteries or AC-DC converters can be adapted as power supply for various light sources.

The possible applications are enormous in areas as diverse as art, fashion, entertainment, toys, as well as communication. In particular articles capable of being manufactured from these photonic fabric displays of the invention are:
Apparel or garments with various color patterns;
Sport articles with various color patterns;
Accessories with various color patterns;
Interior decoration with various color patterns (curtains, tents, moquette, arras (tapestry), coatings, pillows, covers, bed sheet, wall papers, etc.);
Articles with various color patterns for the car (upholstery);
Safety articles with various color patterns;
Advertising articles (such as portable poster);
Adornments and arts (such as decorative pictures, paintings, vases or cornices);
Illuminative articles replaced the traditional lighting (such as lamp-chimney for floodlight, head lamp, jacklight, spotlight);
Wall maps for decoration;
Scientific popularization articles (such as wall map, globe map, propagandistic articles, etc.);
Toys with lighting and color patterns;
Entertainment articles;
Gifts (such three dimension Christmas cards)
Fabric display screen.

FIG. 5 shows a painting-formatted art decors made from the invented photonic fabric. Harbor View of Hong Kong was vividly expressed by the invented photonic fabric. The good effect of various color patterns with color change and luminescent intensity amplification has been obtained. The patterns, luminescent effects, and display mode can be controlled by the electronic circuits.

We claim:

1. A photonic fabric display, comprising a plurality of photonic fibers which contains a converter either coated on a surface of said photonic fibers or incorporated inside said photonic fibers and a light source connected to an end of said photonic fibers.

2. The photonic fabric display of claim 1, wherein said light source is an LED.

3. The photonic fabric display of claim 2, further comprising a coupler connecting said end of said photonic fibers and said LED, wherein a gap between said end of said photonic fibers and a cap of said LED is filled with a substance having a reflective index substantially equal to that of said cap of said LED.

4. The photonic fabric display of claim 3, wherein said substance having a reflective index is substantially equal to that of a PMMA core of said photonic fibers

5. The photonic fabric display of claim 4, wherein said substance is an optic resin.
